(19) United States
(12) Patent Application Publication
(10) Pub. No.: US 2023/0384170 A1
(43) Pub. Date: Nov. 30, 2023

(54) TEMPERATURE SENSING BASED ON METAL RAILS WITH DIFFERENT THERMAL-RESISTANCE COEFFICIENTS

(71) Applicant: Taiwan Semiconductor Manufacturing Company, Ltd., Hsinchu (TW)

(72) Inventors: Szu-Lin Liu, Hsinchu City (TW); Wei-Lin Lai, Hsinchu City (TW); Bei-Shing Lien, Taipei City (TW)

(73) Assignee: Taiwan Semiconductor Manufacturing Company, Ltd., Hsinchu (TW)

(21) Appl. No.: 18/170,401

(22) Filed: Feb. 16, 2023

Related U.S. Application Data
(60) Provisional application No. 63/345,521, filed on May 25, 2022.
(60) Provisional application No. 63/409,999, filed on Sep. 26, 2022.

(51) Int. Cl. G01K 7/20; G01K 7/18

(52) U.S. Cl. CPC G01K 7/20; G01K 7/183

(57) ABSTRACT

Disclosed herein are related to a device and a method for sensing a temperature. In one aspect, the device includes a first resistor including a first metal rail in a first layer. The first metal rail may have a first thermal-resistance coefficient. In one aspect, the device includes a second resistor including a second metal rail in a second layer above the first layer along a direction. The second metal rail may have a second thermal-resistance coefficient. In one aspect, the device includes a sensing circuit coupled to the first resistor and the second resistor. The sensing circuit may be configured to determine a temperature, according to the first metal rail having the first thermal-resistance coefficient and the second metal rail having the second thermal-resistance coefficient.

### CROSS-REFERENCE TO RELATED APPLICATION

This application claims priority to and the benefit of U.S. Provisional Patent Application No. 63/345,521, filed on May 25, 2022, and U.S. Patent App. No. 63/409,999, filed Sep. 26, 2022, the entire disclosures of both of which are incorporated by reference in their entireties.

### BACKGROUND

Performance of an electronic device is temperature dependent. For example, a mobility of electrons or holes can change, according to a temperature. In particular, a mobility of electrons or holes can be decreased, as the temperature increases. Accordingly, as the temperature increases, an operating speed of the electronic device may decrease. Similarly, an operating speed of the electronic device may increase, as the temperature decreases. To ensure that the electronic device operates consistently for a wide temperature range, a sensing circuit can be implemented to detect a temperature. According to the detected temperature, an operation of the electronic device can be adjusted. For example, if a temperature rises, then more power can be provided to the electronic device, such that that the electronic device can still operate at a target operating speed. Similarly, if a temperature decreases, then less power can be provided to the electronic device, such that that the electronic device can still operate at the target operating speed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross sectional diagram showing a layer stack of a device including components for detecting a temperature, in accordance with some embodiments.

FIG. 2A is a top plan view of a layer showing a first set of metal rails implemented as a first resistor, in accordance with one embodiment.

FIG. 2B is a top plan view of a layer showing a second set of metal rails implemented as a capacitor, in accordance with one embodiment.

FIG. 2C is a top plan view of a layer showing a third set of metal rails implemented as a resistor, in accordance with one embodiment.

FIG. 2D is a top plan view of a layer showing a fourth set of metal rails implemented as a capacitor, in accordance with one embodiment.

FIG. 2E is a top plan view of a combination of layers including the first set of metal rail, the second set of metal rail, the third set of metal rails, and the fourth set of metal rails shown in FIGS. 2A-2D, in accordance with one embodiment.

FIG. 3 is a schematic diagram of a device to detect a temperature, in accordance with one embodiment.

FIG. 4 is timing diagram showing pulses generated by different resistors of a device for a temperature detection, in accordance with one embodiment.

FIG. 5 is a plot showing changes in timing responses of different resistors for a change in a temperature, in accordance with one embodiment.

FIG. 6 is a schematic diagram of a sensing circuit, in accordance with one embodiment.

FIG. 7 is a flowchart showing a method of sensing a temperature by a device including two resistors in two different layers, in accordance with some embodiments.

FIG. 8 is a schematic diagram of a device to detect a temperature, in accordance with one embodiment.

FIG. 9 is timing diagram showing a pulse generated by different resistors of a device for a temperature detection, in accordance with one embodiment.

FIG. 10 is a schematic diagram of a sensing circuit, in accordance with one embodiment.

FIG. 11 is a flowchart showing a method of sensing a temperature by a device including two resistors in two different layers, in accordance with some embodiments.

FIG. 12 is a schematic diagram of a device to detect a temperature, in accordance with one embodiment.

FIG. 13 is a schematic diagram of a sensing circuit, in accordance with one embodiment.

FIG. 14 is a flowchart showing a method of sensing a temperature by a device including two resistors in two different layers, in accordance with some embodiments.

FIG. 15 is a flowchart showing a method of fabricating a device including resistors in different layers for temperature sensing, in accordance with some embodiments.

FIG. 16 is an example block diagram of a computing system, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Disclosed herein are related to a device and a method for sensing a temperature. In one aspect, the device includes a first resistor and a second resistor having different thermal-resistance coefficients. A thermal-resistance coefficient of a resistor may indicate or correspond to an amount of change in a resistance of the resistor, in response to an amount of change in a temperature of the resistor. In one aspect, the first resistor includes a first metal rail in a first layer, and the second resistor includes a second metal rail in a second layer above the first layer. The first metal rail and the second metal rail may have different thicknesses, different widths, different materials or any combination of them in different layers, such that the first metal rail and the second metal rail may have different thermal-resistance coefficients. In one aspect, the device includes a sensing circuit coupled to the first resistor and the second resistor. The sensing circuit may be configured to determine a temperature, according to the first metal rail having the first thermal-resistance coefficient and the second metal rail having the second thermal-resistance coefficient.

In one example, the sensing circuit can apply one or more voltage pulses to the first resistor and the second resistor, and compare timing responses of the first resistor and the second resistor, in response to the one or more voltage pulses. According to the timing responses of the first resistor and the second resistor, the sensing circuit may determine a temperature.

In one example, the sensing circuit can apply a current to the first resistor and the second resistor, and compare voltages of the first resistor and the second resistor, in response to the current applied. According to the voltages of the first resistor and the second resistor, the sensing circuit may determine a temperature.

Advantageously, the disclosed device for detecting a temperature can be implemented in a small form factor. For example, the first resistor including the first metal rail can be implemented in a first layer, and the second resistor including the second metal rail can be implemented in a second layer above the first layer along a direction. The sensing circuit can be implemented in a third layer, where the first layer is disposed above the third layer along the direction. Hence, the sensing circuit, the first resistor, and the second resistor can be stacked along the direction to achieve area efficiency.

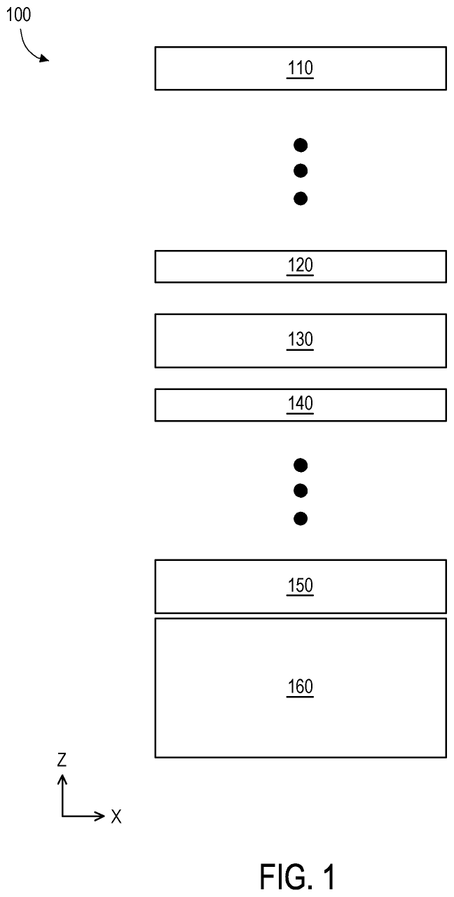

FIG. 1 is a cross sectional diagram showing a layer stack of a device 100 including components for detecting a temperature, in accordance with some embodiments. The device 100 can be an integrated circuit. In some embodiments, the device 100 includes layers 160, 150, 140, 130, 120, 110 stacked along a Z-direction. The layer 160 may be in a front end of line (FEOL) layer including one or more circuits, where the layers 150, 140, 130, 120, 110 may be in a back end of line (BEOL) layer. In some embodiments, the device 100 includes more, fewer, or different layers than shown in FIG. 1.

In one aspect, the layer 160 includes active components, such as transistors that can form a sensing circuit. In one aspect, the layers 150, 140, 130, 120, 110 includes passive components, such metal rails. The metal rails can be implemented for routing, or implemented as resistors or capacitors. In one example, the layer 110 includes one or more resistors formed by metal rails. In one example, the layer 120 includes one or more capacitors formed by one or more metal rails. In one example, the layer 130 includes one or more resistors formed by metal rails. In one example, the layer 140 includes one or more capacitors formed by one or more metal rails. In one example, the layer 150 includes one or more metal rails for routing or providing signals to active components (e.g., transistors) in the layer 160.

In one aspect, the device 100 can detect a temperature based on different temperature characteristics of a first resistor in the layer 130 and a second resistor in the layer 110. A thermal-resistance coefficient of a component (e.g., a resistor or a metal rail of the resistor) may indicate or may correspond to an amount of change in a resistance of the component, in response to an amount of change in a temperature. In one aspect, metal rails in the layer 110 and metal rails in the layer 130 may have different thicknesses, different widths, different materials or any combination of them, such that the first resistor in the layer 130 and the second resistor in the layer 110 may have different thermal-resistance coefficients. According to different thermal-resistance coefficients, the first resistor in the layer 130 and the second resistor in the layer 110 may have different timing responses and/or voltage responses for a change in temperature. In one aspect, the layer 160 includes a sensing circuit that can detect timing responses and/or voltage responses of the first resistor in the layer 130 and the second resistor in the layer 110, and determine a temperature, according to the detected timing responses and/or voltage responses.

Advantageously, the device 100 for detecting a temperature can be implemented in a small form factor to achieve area efficiency. For example, passive components such as resistors and/or capacitors may occupy a larger area than active components (e.g., transistors). By implementing resistors, capacitors, and a sensing circuit vertically along the Z-direction, rather than on the same layer, the device 100 can be implemented in a small area.

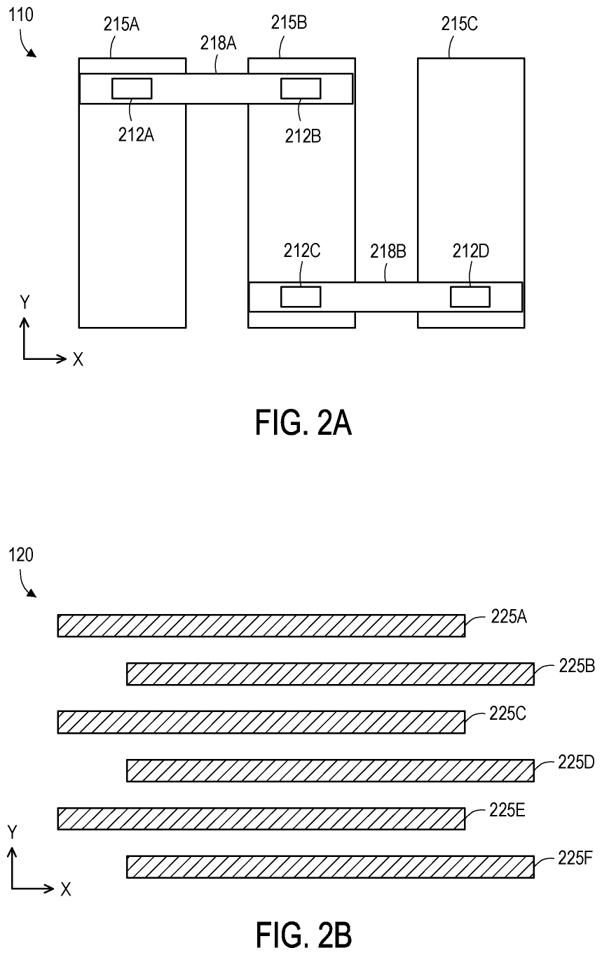

FIG. 2A is a top plan view of the layer 110 showing a first set of metal rails 215A-215C implemented as a first resistor, in accordance with one embodiment. FIG. 2B is a top plan view of the layer 120 showing a second set of metal rails 225A-225F implemented as a capacitor, in accordance with one embodiment. FIG. 2C is a top plan view of the layer 130 showing a third set of metal rails 235A-235G implemented as a resistor, in accordance with one embodiment. FIG. 2D is a top plan view of the layer 140 showing a fourth set of metal rails 245A-245F implemented as a capacitor, in accordance with one embodiment. FIG. 2E is a top plan view of a combination 250 of the layers 110-140 including the first set of metal rails 215, the second set of metal rails 225, the third set of metal rails 235, and the fourth set of metal rails 245 shown in FIGS. 2A-2D, in accordance with one embodiment.

In some embodiments, the layer 110 includes a set of metal rails 215A, 215B, 215C, extending along a Y-direction. The metal rails 215A, 215B, 215C may include conductive materials with a particular thermal-resistance coefficient. In one configuration, an end portion of the metal rail 215A is coupled to an end portion of the metal rail 215B through via contacts 212A, 212B and a metal rail 218A extending along a X-direction. In one configuration, an end portion of the metal rail 215B is coupled to an end portion of the metal rail 215C through via contacts 212C, 212D and a metal rail 218B extending along the X-direction. The metal rails 218A, 218B may be in a layer above or below the layer 110 along the Z-direction. In some embodiments, the set of metal rails 215A, 215B, 215C can be electrically coupled to each other through additional via contacts 212 and metal rails 218 than shown in FIG. 2A. In this configuration, the set of metal rails 215A, 215B, 215C can be daisy chained and electrically coupled to each other to form or constitute a resistor. In some embodiments, the layer 110 includes a different number of metal rails 215 than shown in FIG. 2A.

In some embodiments, the layer 120 includes a set of metal rails 225A-225F extending along the X-direction. The metal rails 225A-225F may include conductive materials. In one configuration, each of the set of metal rails 225A-225F operates as a metal plate, where one plate faces an adjacent plate along the Y-direction. For example, a surface of the metal rail 225F faces a surface of the metal rail 225E along the Y-direction. For example, another surface of the metal rail 225E faces a surface of the metal rail 225D along the Y-direction. In one configuration, the metal rails 225A, 225C, 225E can be electrically coupled to each other, and the metal rails 225B, 225D, 225F can be electrically coupled to each other. In this configuration, the set of metal rails 225A-225F can operate as a capacitor (e.g., metal-oxide-metal capacitor). In some embodiments, the layer 120 includes a different number of metal rails 225 than shown in FIG. 2B.

In some embodiments, the layer 130 includes a set of metal rails 235A-235G extending along a Y-direction. The metal rails 235A-235G may include conductive materials with a particular thermal-resistance coefficient different from a thermal-resistance coefficient of the metal rails 215A-215C. Each of the metal rails 235A-235G may have a different width along the X-direction than each of the metal rails 215A-215C. The metal rails 235A-235G may be coupled to each other through metal rails 238AA-238FB. The metal rails 238AA-238FB may be in a layer above or below the layer 130. In one configuration, an end portion of the metal rail 235A is coupled to an end portion of the metal rail 235B i) through via contacts 232AA, 232BA and a metal rail 238AA and ii) through via contacts 232AB, 232BB and a metal rail 238AB extending along the X-direction. In one configuration, an end portion of the metal rail 235B is coupled to an end portion of the metal rail 235C i) through via contacts 232CA, 232DA and a metal rail 238BA and ii) through via contacts 232CB, 232DB and a metal rail 238BB extending along the X-direction. Remaining metal rails 235C-235G can be daisy chained in a similar manner through via contacts 232EA-232LB and metal rails 238CA-238FB. In some embodiments, the set of metal rails 235A-235G can be electrically coupled to each other through additional via contacts 232 and metal rails 238 than shown in FIG. 2C. In one aspect, two metal rails 235 are coupled to each other through four via contacts 232 and two metal rails 238 to reduce a resistance between the two metal rails 235. In this configuration, the set of metal rails 235A-235G can be electrically coupled to each other to form or constitute a resistor. In some embodiments, the layer 130 includes a different number of metal rails 235 than shown in FIG. 2C.

In some embodiments, the layer 140 includes a set of metal rails 245A-245F extending along the X-direction. The metal rails 245A-245F may include conductive materials. In one configuration, each of the set of metal rails 245A-245F operates as a metal plate, where one plate faces an adjacent plate along the Y-direction. For example, a surface of the metal rail 245F faces a surface of the metal rail 245E along the Y-direction. For example, another surface of the metal rail 245E faces a surface of the metal rail 245D along the Y-direction. In one configuration, the metal rails 245A, 245C, 245E can be electrically coupled to each other, and the metal rails 245B, 245D, 245F can be electrically coupled to each other. In this configuration, the set of metal rails 245A-245F can operate as a capacitor (e.g., metal-oxide-metal capacitor). In some embodiments, the layer 140 includes a different number of metal rails 245 than shown in FIG. 2D.

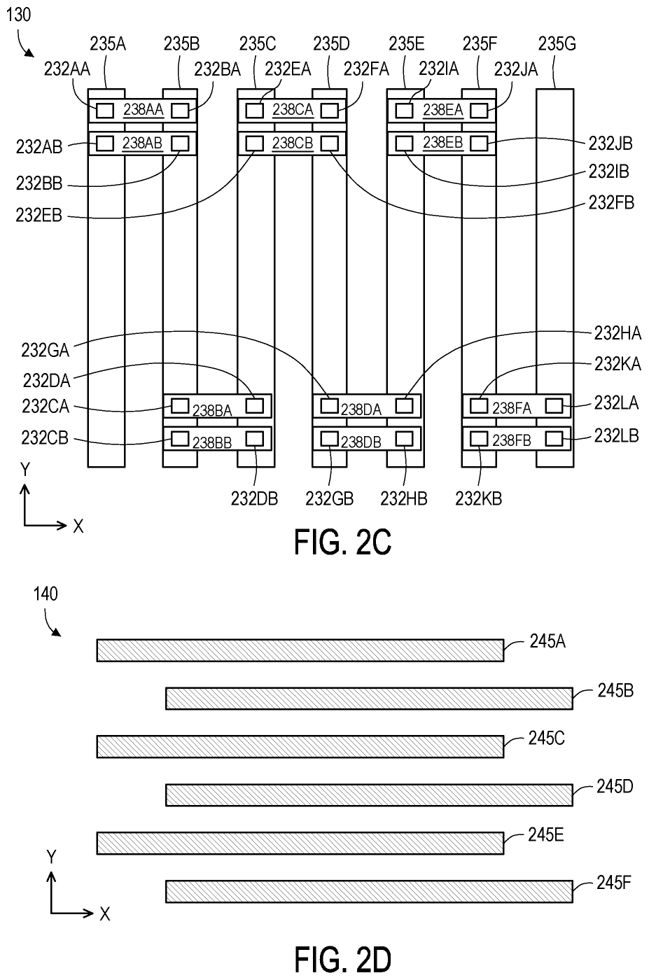

FIG. 3 is a schematic diagram of a device 100A to detect a temperature, in accordance with one embodiment. The device 100A can be the device 100 of FIG. 1. In some embodiments, the device 100A includes resistors R1, R2, R3, R4, capacitors C1, C2, switches SW1-SW4, and a sensing circuit 350. These components may operate together to detect or determine a temperature of the device 100A. In some embodiments, the resistors R1, R2 may be resistors in the layer 130, and the resistors R3, R4 may be resistors in the layer 110. In some embodiments, the switches SW1-SW4 can be implemented as transistors. In some embodiments, the switches SW1-SW4 and the sensing circuit 350 are implemented in the layer 160. In some embodiments, the capacitors C1, C2 are implemented in the layer 120, in the layer 140 or both. In some embodiments, the device 100A includes more, fewer, or different components than shown in FIG. 3.

In one configuration, the resistor R1 includes a first electrode coupled to a metal rail providing a supply voltage (e.g., VDD or 1V) and a second electrode coupled to a first electrode of the switch SW1. In one configuration, a second electrode of the switch SW1 is coupled to a first input of the sensing circuit 350. In one configuration, the resistor R2 includes a first electrode coupled to a metal rail providing a ground voltage (e.g., GND or 0V) and a second electrode coupled to a first electrode of the switch SW2. In one configuration, a second electrode of the switch SW2 is coupled to the first input of the sensing circuit 350. In one configuration, the capacitor C1 includes a first electrode coupled to the metal rail providing the ground voltage (e.g., GND or 0V) and a second electrode coupled to the first input of the sensing circuit 350. In one aspect, the resistors R1, R2 in the layer 130 may have the same dimension or size with each other.

In one configuration, the resistor R3 includes a first electrode coupled to the metal rail providing the supply voltage (e.g., VDD or 1V) and a second electrode coupled to a first electrode of the switch SW3. In one configuration, a second electrode of the switch SW3 is coupled to a second input of the sensing circuit 350. In one configuration, the resistor R4 includes a first electrode coupled to the metal rail providing the ground voltage (e.g., GND or 0V) and a second electrode coupled to a first electrode of the switch SW4. In one configuration, a second electrode of the switch SW4 is coupled to the second input of the sensing circuit 350. In one configuration, the capacitor C2 includes a first electrode coupled to the metal rail providing the ground voltage (e.g., GND or 0V) and a second electrode coupled to the second input of the sensing circuit 350. In one aspect, the resistors R3, R4 in the layer 110 may have the same dimension or size with each other.

In this configuration, the sensing circuit 350 can determine a temperature of the device 100A, based on different thermal-resistance coefficients of the resistors R1, R2, R3, R4. In one aspect, the sensing circuit 350 may determine the temperature of the device 100A, according to timing responses of the resistors R1, R2, R3, R4. For example, the capacitors C1, C2 may have the same capacitance, but the resistors R1, R2 in the layer 130 and the resistors R3, R4 in the layer 110 may have different thermal-resistance coefficients, such that the resistors in the layer 130 and the resistors R3, R4 in the layer 110 may provide different timing responses. In one aspect, the sensing circuit 350 may configure the switches SW1, SW2, SW3, SW4, such that the capacitors C1, C2 can be charged or discharged. For example, the sensing circuit 350 can enable the switch SW1 and disable the switch SW2, such that the capacitor C1 can be electrically coupled to the metal rail providing the supply voltage VDD through the resistor R1 to charge the capacitor C1. For example, the sensing circuit 350 can enable the switch SW2 and disable the switch SW1, such that the capacitor C1 can be electrically coupled to the metal rail providing the ground voltage GND through the resistor R2 to discharge the capacitor C1. The sensing circuit 350 can configure the switches SW3, SW4 in a similar manner to charge or discharge the capacitor C2. In one aspect, time for charging or discharging a capacitor may depend on a resistance of one or more resistors coupled to the capacitor. Hence, when a resistance changes due to a temperature change, time for charging or discharging a capacitor may change, accordingly. The sensing circuit 350 can monitor a first voltage V1 at the first input and a second voltage V2 at the second input to determine charging and/or discharging of the capacitors C1, C2, and detect or determine the temperature according to the determined charging and/or discharging of the capacitors C1, C2.

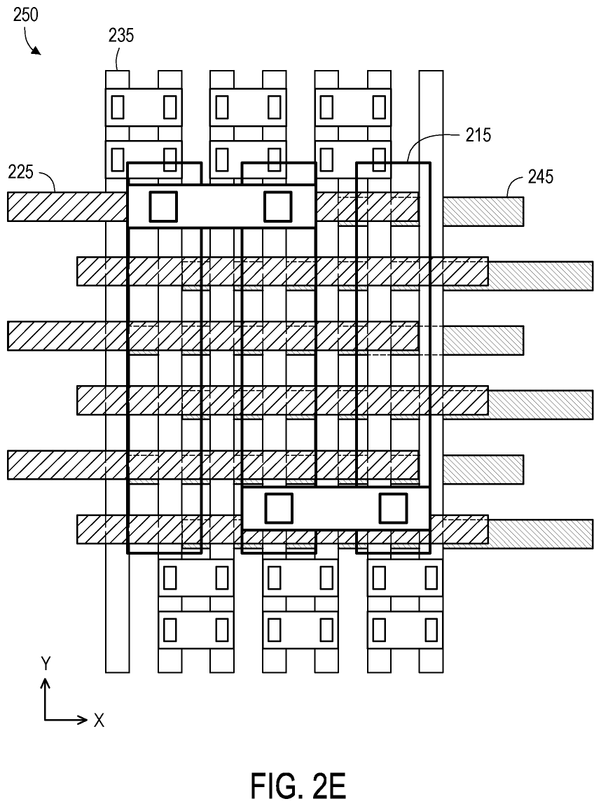

FIG. 4 is timing diagram 400 showing pulses generated by resistors R1, R2, R3, R4 of the device 100A for a temperature detection, in accordance with one embodiment. In one approach, the switches SW1, SW2 can be configured or operated, according to the pulse S1, and the switches SW3, SW4 can be configured or operated, according to the pulse S2. For example, when the pulse S1 has a high voltage (e.g., VDD or 1V), the switch SW1 can be enabled and the switch SW2 can be disabled, such that the capacitor C1 can be charged and the voltage V1 at the first input of the sensing circuit 350 can increase. For example, when the pulse S1 has a low voltage (e.g., GND or 0V), the switch SW1 can be disabled and the switch SW2 can be enabled, such that the capacitor C1 can be discharged and the voltage V1 at the first input of the sensing circuit 350 can decrease. Similarly, for example, when the pulse S2 has a high voltage (e.g., VDD or 1V), the switch SW3 can be enabled and the switch SW4 can be disabled, such that the capacitor C2 can be charged and the voltage V2 at the second input of the sensing circuit 350 can increase. For example, when the pulse S2 has a low voltage (e.g., GND or 0V), the switch SW3 can be disabled and the switch SW4 can be enabled, such that the capacitor C2 can be discharged and the voltage V2 at the second input of the sensing circuit 350 can decrease.

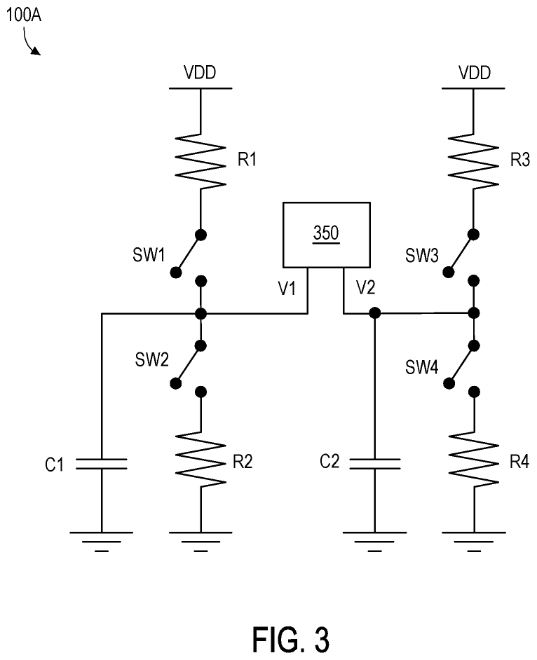

In one aspect, the sensing circuit 350 can detect or determine time periods T1, T2 for charging and/or discharging of the capacitors C1, C2 through resistors R1, R2, R3, R4, and determine a temperature, according to the time periods T1, T2. In one aspect, the time periods T1, T2 for charging and/or discharging capacitors C1, C2 can change, according to differences in thermal-resistance coefficients of the resistors R1, R2, R3, R4, as described below with respect to FIG. 5.

FIG. 5 is a plot 500 showing changes in timing responses of different resistors R1, R2, R3, R4 for a change in a temperature, in accordance with one embodiment. For example, the resistors R1, R2 in the layer 130 may have a higher thermal-resistance coefficient than the resistors R3, R4 in the layer 110, such that as the temperature increases, the time period T1 for charging or discharging the capacitor C1 may increase by a larger amount than the time period T2 for charging or discharging the capacitor C2. In one approach, the sensing circuit 350 can compare the time period T1 for charging and/or discharging the capacitor C1, and the time period T2 for charging and/or discharging the capacitor C2. If the time period T1 for charging and/or discharging the capacitor C1 is shorter than the time period T2 for charging and/or discharging the capacitor C2, then the sensing circuit 350 may determine that the temperature is lower than a threshold temperature Tth. If the time period T1 for charging and/or discharging the capacitor C1 is longer than the time period T2 for charging and/or discharging the capacitor C2, then the sensing circuit 350 may determine that the temperature is higher than the threshold temperature Tth.

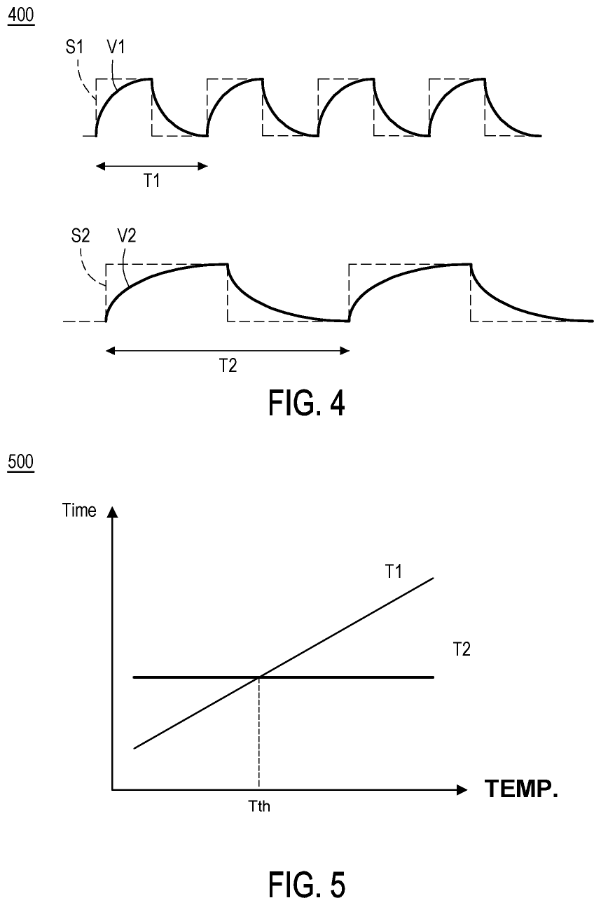

FIG. 6 is a schematic diagram of the sensing circuit 350, in accordance with one embodiment. In some embodiments, the sensing circuit 350 includes amplifiers 610A, 610B, counter circuits 620A, 620B, and a control circuit 650. These components may operate together to detect voltages V1, V2 at the first input and the second input, respectively, and determine a temperature, according to the detected voltages V1, V2. In some embodiments, the sensing circuit 350 includes more, fewer, or different components than shown in FIG. 6. In some embodiments, the amplifiers 610A, 610B can be omitted.

In some embodiments, the amplifier 610A is a circuit or a component that can amplify the voltage V1. The amplifier 610A can be implemented as a buffer, even number of cascaded inverters, or any circuit that can amplify a voltage. In some embodiments, the amplifier 610A can be replaced by a different component that can perform the functions of the amplifier 610A, disclosed herein. In one configuration, the amplifier 610A includes an input to receive the voltage V1, and an output coupled to an input of the counter circuit 620A. In this configuration, the amplifier 610A can amplify the voltage V1 to obtain an amplified voltage V1′, and provide the amplified voltage V1′ to the counter circuit 620A.

In some embodiments, the counter circuit 620A is a circuit or a component that can count a number of pulses of a clock signal for the amplified voltage V1′ to reach from one voltage (e.g., VDD or GND) to another voltage (e.g., GND or VDD). The counter circuit 620A can be implemented as logic circuits, such as a set of registers or flip flops. In some embodiments, the counter circuit 620A can be replaced by a different component that can perform the functions of the counter circuit 620A disclosed herein. In one configuration, the counter circuit 620A includes an input coupled to the output of the amplifier 610A, and an output coupled to a first input of the control circuit 650. In this configuration, the counter circuit 620A can track the amplified voltage V1′, and obtain a number D1 of pulses of a clock signal for the amplified voltage V1′ to reach from one voltage (e.g., VDD or GND) to another voltage (e.g., GND or VDD). In one aspect, the number D1 of pulses may correspond to the time period T1. The counter circuit 620A may provide a signal indicating the number D1 of pulses to the control circuit 650.

In some embodiments, the amplifier 610B and the counter circuit 620B can be configured and operated in a similar manner as the amplifier 610A and the counter circuit 620A, respectively. Hence, the amplifier 610B can amplify the voltage V2 to obtain an amplified voltage V2′. The counter circuit 620B can track the amplified voltage V2′, and obtain a number D2 of pulses of a clock signal for the amplified voltage V2′ to reach from one voltage (e.g., VDD or GND) to another voltage (e.g., GND or VDD). In one aspect, the number D2 of pulses may correspond to the time period T2. The counter circuit 620B may provide a signal indicating the number D2 of pulses to the control circuit 650.

In some embodiments, the control circuit 650 is a circuit or a component that can determine a temperature, according to the number D1 of pulses and the number D2 of pulses. In some embodiments, the control circuit 650 is implemented as a logic circuit. In some embodiments, the control circuit 650 can be replaced by a different circuit or a component, that can perform the functions of the control circuit 650 disclosed herein. In one configuration, the control circuit 650 includes the first input to receive a signal indicating the number D1 of pulses from the counter circuit 620A and the second input to receive a signal indicating the number D2 of pulses from the counter circuit 620B. The control circuit 650 may be also coupled to the switches SW1-SW4. In this configuration, the control circuit 650 may configure the switches SW1-SW4 to charge or discharge the capacitors C1, C2. Meanwhile, the control circuit 650 may receive a signal indicating the number D1 of pulses and a signal indicating the number D2 of pulses. The control circuit 650 may compare the number D1 of pulses and the number D2 of pulses, and determine the temperature, according to the comparison. For example, if the number D1 of pulses is less than the number D2 of pulses, then the control circuit 650 may determine that the temperature is lower than a threshold temperature Tth. For example, if the number D1 of pulses is larger than the number D2 of pulses, then the control circuit 650 may determine that the temperature is higher than the threshold temperature Tth.

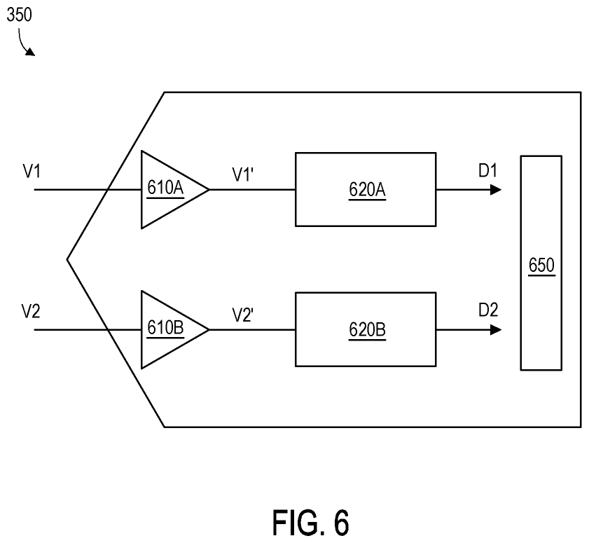

FIG. 7 is a flowchart showing a method 700 of sensing a temperature by a device 100A including resistors (e.g., resistors R1, R2) in a first layer (e.g., layer 130) and resistors (e.g., resistors R3, R4) in a second layer (e.g., layer 110) above the first layer, in accordance with some embodiments. In some embodiments, the method 700 is performed by a device (e.g., device 110A). In some embodiments, the method 700 is performed by a different entity. In some embodiments, the method 700 includes more, fewer, or different steps than shown in FIG. 7.

In one approach, the device charges or discharges 710 a first capacitor (e.g., capacitor C1) through a first resistor (e.g., resistor R1 or resistor R2) in the first layer (e.g., layer 130). For example, a first switch (e.g., switch SW1) coupled to a resistor (e.g., resistor R1) in the first layer (e.g., layer 130) can be enabled and a second switch (e.g., switch SW2) coupled to another resistor (e.g., resistor R2) in the first layer (e.g., layer 130) can be disabled to charge the capacitor C1. For example, the first switch (e.g., switch SW1) coupled to the resistor (e.g., resistor R1) in the first layer (e.g., layer 130) can be disabled and the second switch (e.g., switch SW2) coupled to the another resistor (e.g., resistor R2) in the first layer (e.g., layer 130) can be enabled to discharge the capacitor C1.

In one approach, the device charges and discharges 720 a second capacitor (e.g., capacitor C2) through a second resistor (e.g., resistor R3 or resistor R4) in the second layer (e.g., layer 110). For example, a third switch (e.g., switch SW3) coupled to a resistor (e.g., resistor R3) in the second layer (e.g., layer 110) can be enabled and a fourth switch (e.g., switch SW4) coupled to another resistor (e.g., resistor R4) in the second layer (e.g., layer 110) can be disabled to charge the capacitor C2. For example, the third switch (e.g., switch SW3) coupled to the resistor (e.g., resistor R3) in the second layer (e.g., layer 110) can be disabled and the fourth switch (e.g., switch SW4) coupled to the another resistor (e.g., resistor R4) in the second layer (e.g., layer 110) can be enabled to discharge the capacitor C2.

In one approach, the device determines 730 a first time period (e.g., time period T1) for charging and discharging the first capacitor (e.g., capacitor C1) through the first resistor (e.g., resistor R1 or resistor R2) in the first layer (e.g., layer 130). For example, the device can count a number of pulses of a clock signal for a voltage at the capacitor C1 to reach from one voltage (e.g., VDD or GND) to another voltage (e.g., GND or VDD). The number of pulses counted (e.g., number D1 of pulses) may indicate or correspond to the first time period (e.g., time period T1).

In one approach, the device determines 740 a second time period (e.g., time period T2) for charging and discharging the second capacitor (e.g., capacitor C2) through the second resistor (e.g., resistor R3 or resistor R4) in the second layer (e.g., layer 110). For example, the device can count a number of pulses of the clock signal for a voltage at the capacitor C2 to reach from one voltage (e.g., VDD or GND) to another voltage (e.g., GND or VDD). The number of pulses counted (e.g., number D2 of pulses) may indicate or correspond to the second time period (e.g., time period T2).

In one approach, the device determines 750 a temperature, according to the first time period and the second time period. In one aspect, the first time period for charging and discharging and the second time period for charging and discharging may be temperature dependent, because the first resistor (e.g., resistor R1) and the second resistor (e.g., resistor R2) in the first layer (e.g., layer 130) and the third resistor (e.g., resistor R3) and the fourth resistor (e.g., R4) in the second layer (e.g., layer 110) may have different thermal-resistance coefficients. For example, the device may compare the number of pulses counted (e.g., number D1 of pulses) for charging and discharging the first capacitor (e.g., capacitor C1) and the number of pulses counted (e.g., number D2 of pulses) for charging and discharging the second capacitor (e.g., second capacitor C2), and determine the temperature according to the comparison. For example, if the number of pulses counted (e.g., number D1 of pulses) for charging and discharging the capacitor C1 is less than the number of pulses counted (e.g., the number D2 of pulses) for charging and discharging the capacitor C2, then the device may determine that the temperature is lower than a threshold temperature Tth. For example, if the number of pulses counted (e.g., number D1 of pulses) for charging and discharging the capacitor C1 is larger than the number of pulses counted (e.g., number D2 of pulses) for charging and discharging the capacitor C2, then the device may determine that the temperature is higher than the threshold temperature Tth.

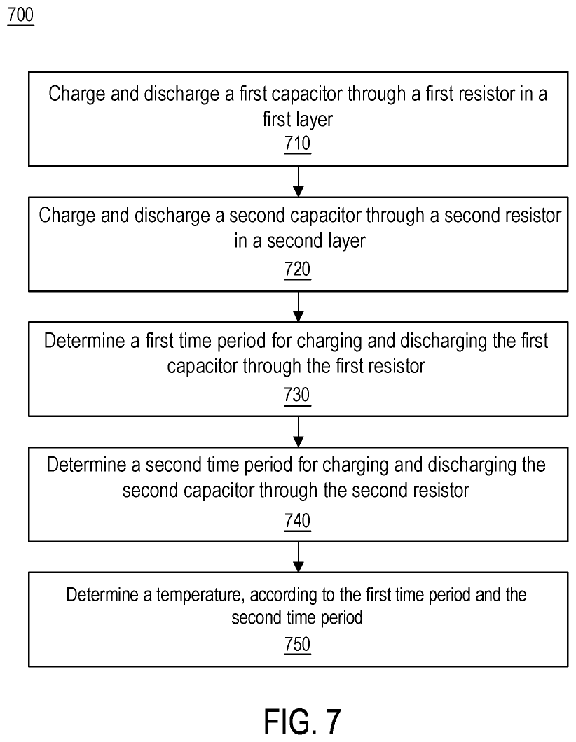

FIG. 8 is a schematic diagram of a device 100B to detect a temperature, in accordance with one embodiment. The device 100B can be the device 100 of FIG. 1. In some embodiments, the device 100B includes resistors R5, R6, capacitor C3, switches SW5, SW6, and a sensing circuit 850. These components may operate together to detect or determine a temperature of the device 100B. In some embodiments, the resistor R5 may be a resistor in the layer 130, and the resistor R6 may be a resistor in the layer 110. In some embodiments, the switches SW5, SW6 can be implemented as transistors. In some embodiments, the switches SW5, SW6, and the sensing circuit 850 are implemented in the layer 160. In some embodiments, the capacitor C3 is implemented in the layer 120, in the layer 140 or both. In some embodiments, the device 100B includes more, fewer, or different components than shown in FIG. 8.

In one configuration, the resistor R6 includes a first electrode coupled to a metal rail providing a supply voltage (e.g., VDD or 1V) and a second electrode coupled to a first electrode of the switch SW6. In one configuration, a second electrode of the switch SW6 is coupled to an input of the sensing circuit 850. In one configuration, the resistor R5 includes a first electrode coupled to a metal rail providing a ground voltage (e.g., GND or 0V) and a second electrode coupled to a first electrode of the switch SW5. In one configuration, a second electrode of the switch SW5 is coupled to the input of the sensing circuit 850. In one configuration, the capacitor C3 includes a first electrode coupled to the metal rail providing the ground voltage (e.g., GND or 0V) and a second electrode coupled to the input of the sensing circuit 850.

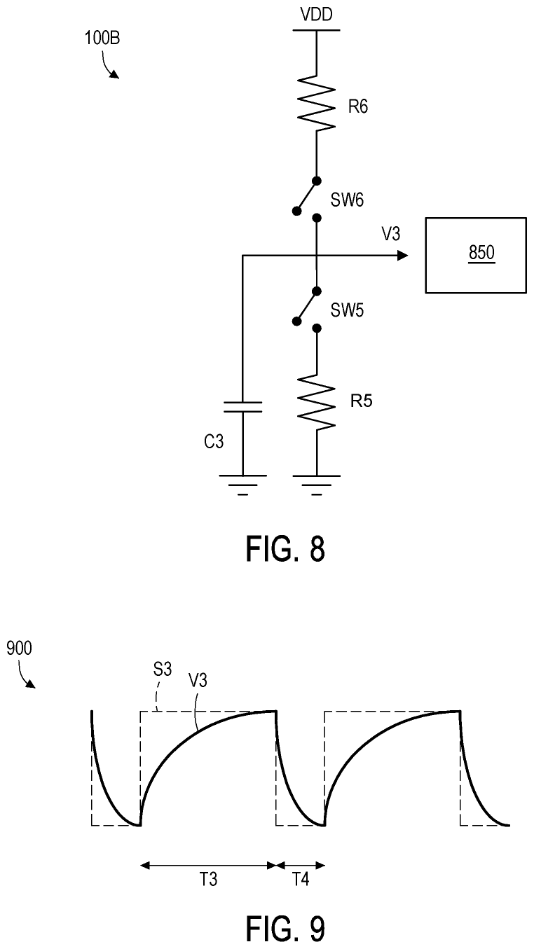

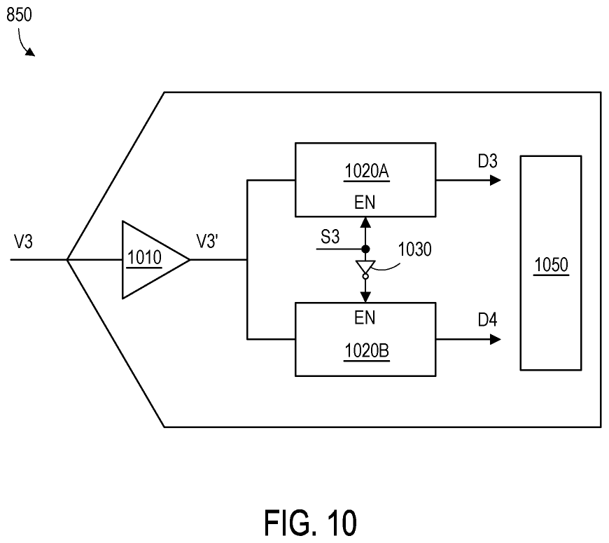

In this configuration, the sensing circuit 850 can determine a temperature of the device 100B, based on different thermal-resistance coefficients of the resistors R5, R6. In one aspect, the sensing circuit 850 is similar to the sensing circuit 350, except the sensing circuit 850 determines a timing response of the resistor R6 in the layer 110 through charging of the capacitor C3, and determines a timing response of the resistor R5 in the layer 130 through discharging of the capacitor C3. For example, the sensing circuit 850 can enable the switch SW6 and disable the switch SW5, such that the capacitor C3 can be electrically coupled to the metal rail providing the supply voltage VDD through the resistor R6 to charge the capacitor C3. When charging the capacitor C3, the sensing circuit 850 can determine the timing response of the resistor R6. For example, the sensing circuit 850 can enable the switch SW5 and disable the switch SW6, such that the capacitor C3 can be electrically coupled to the metal rail providing the ground voltage GND through the resistor R5 to discharge the capacitor C3. When discharging the capacitor C3, the sensing circuit 850 can determine the timing response of the resistor R5. According to the timing responses, the sensing circuit 850 can detect or determine the temperature, as described below with respect to FIGS. 9 and 10.

FIG. 9 is timing diagram 900 showing a pulse generated by different resistors R5, R6 of the device 100B for a temperature detection, in accordance with one embodiment. In one approach, the switches SW3, SW4 can be configured or operated, according to the pulse S3. For example, when the pulse S3 has a high voltage (e.g., VDD or 1V), the switch SW6 can be enabled and the switch SW5 can be disabled, such that the capacitor C3 can be charged and the voltage V3 at the input of the sensing circuit 850 can increase. For example, when the pulse S3 has a low voltage (e.g., GND or 0V), the switch SW5 can be enabled and the switch SW6 can be disabled, such that the capacitor C3 can be discharged and the voltage V3 at the input of the sensing circuit 850 can decrease.

In one aspect, the sensing circuit 850 can detect or determine a time period T3 for charging the capacitor C3 through the resistor R6 and a time period T4 for discharging the capacitor C3 through the resistor R5. According to the time periods T3, T4, the sensing circuit 850 may determine a temperature. In one aspect, the time period T3 for charging the capacitor C3 can change, according to a thermal-resistance coefficient of the resistor R6, and the time period T4 for discharging the capacitor C3 can change, according to a thermal-resistance coefficient of the resistor R5. For example, the resistor R5 in the layer 130 may have a higher thermal-resistance coefficient than the resistor R6 in the layer 110, such that as the temperature increases, the time period T4 for discharging the capacitor C3 may increase by a larger amount than the time period T3 for charging the capacitor C3. In one approach, the sensing circuit 850 can compare the time period T3 for charging the capacitor C3, and the time period T4 for discharging the capacitor C3. If the time period T3 for charging the capacitor C3 is longer than the time period T4 for discharging the capacitor C3, then the sensing circuit 850 may determine that the temperature is lower than a threshold temperature Tth. If the time period T3 for charging the capacitor C3 is shorter than the time period T4 for discharging the capacitor C3, then the sensing circuit 850 may determine that the temperature is higher than the threshold temperature Tth.

In some embodiments of the device 100B includes a resistor in the layer 110 to replace the resistor R5 in the layer 130, and a resistor in the layer 130 to replace the resistor R6 layer 110. In such embodiments, the sensing circuit 850 can compare a time period T3 for charging the capacitor C3, and a time period T4 for discharging the capacitor C3, and determine the temperature according to the comparison. For example, if the time period T3 for charging the capacitor C3 is shorter than the time period T4 for discharging the capacitor C3, then the sensing circuit 850 may determine that the temperature is lower than a threshold temperature Tth. If the time period T3 for charging the capacitor C3 is longer than the time period T4 for discharging the capacitor C3, then the sensing circuit 850 may determine that the temperature is higher than the threshold temperature Tth.

FIG. 10 is a schematic diagram of the sensing circuit 850, in accordance with one embodiment. In some embodiments, the sensing circuit 850 includes an amplifier 1010, counter circuits 1020A, 1020B, an inverter 1030, and a control circuit 1050. These components may operate together to detect a voltage V3, and determine a temperature, according to the voltage V3. In some embodiments, the sensing circuit 850 includes more, fewer, or different components than shown in FIG. 10.

In some embodiments, the amplifier 1010 is a circuit or a component that can amplify the voltage V3. The amplifier 1010 can be implemented as a buffer, even number of cascaded inverters, or any circuit that can amplify a voltage. In some embodiments, the amplifier 1010 can be replaced by a different component that can perform the functions of the amplifier 1010 disclosed herein. In one configuration, the amplifier 1010 includes an input to receive the voltage V3, and an output coupled to inputs of the counter circuits 1020A, 1020B. In this configuration, the amplifier 1010 can amplify the voltage V3 to obtain an amplified voltage V3′, and provide the amplified voltage V3′ to the counter circuits 1020A, 1020B.

In some embodiments, the counter circuit 1020A is a circuit or a component that can count a number of pulses of a clock signal for the amplified voltage V3′ to reach from one voltage (e.g., GND) to another voltage (e.g., VDD). The counter circuit 1020A can be implemented as logic circuits, such as a set of registers or flip flops. In some embodiments, the counter circuit 1020A can be replaced by a different component that can perform the functions of the counter circuit 1020A disclosed herein. In one configuration, the counter circuit 1020A includes an input coupled to the output of the amplifier 1010, a clock input to receive the pulse S3, and an output coupled to a first input of the control circuit 1050. In this configuration, the counter circuit 1020A can be enabled, if the pulse S3 has a first voltage (e.g., VDD). The counter circuit 1020A can be disabled, if the pulse S3 has a second voltage (e.g., GND). If the counter circuit 1020A is enabled, the counter circuit 1020 can track the amplified voltage V3′, and obtain a number D3 of pulses of a clock signal for the amplified voltage V3′ to reach from one voltage (e.g., GND) to another voltage (e.g., VDD). In one aspect, the number D3 of pulses of the clock signal may correspond to the time period T3. If the counter circuit 1020A is disabled, the counter circuit 1020A may not track the amplified voltage V3′. The counter circuit 1020A may provide a signal indicating the number D3 of pulses to the control circuit 1050.

In some embodiments, the counter circuit 1020B is a circuit or a component that can count a number of pulses of a clock signal for the amplified voltage V3′ to reach from one voltage (e.g., VDD) to another voltage (e.g., GND). The counter circuit 1020B can be implemented as logic circuits, such as a set of registers or flip flops. In some embodiments, the counter circuit 1020B can be replaced by a different component that can perform the functions of the counter circuit 1020B disclosed herein. In one configuration, the counter circuit 1020B includes an input coupled to the output of the amplifier 1010, a clock input coupled to an output of the inverter 1030 that inverts the pulse S3, and an output coupled to a second input of the control circuit 1050. In this configuration, the counter circuit 1020B can be enabled if the pulse S3 has a second voltage (e.g., GND). The counter circuit 1020B can be disabled if the pulse S3 has a first voltage (e.g., VDD). If the counter circuit 1020B is enabled, the counter circuit 1020B can track the amplified voltage V3′, and obtain a number D4 of pulses of the clock signal for amplified voltage V3′ to reach from one voltage (e.g., VDD) to another voltage (e.g., GND). In one aspect, the number D4 of pulses may correspond to the time period T4. If the counter circuit 1020B is disabled, the counter circuit 1020B may not track the amplified voltage V3′. The counter circuit 1020B may provide a signal indicating the number D4 of pulses of the clock signal to the control circuit 1050.

In some embodiments, the control circuit 1050 is a circuit or a component that can determine a temperature, according to the number D3 of pulses and the number D4 of pulses. In some embodiments, the control circuit 1050 is implemented as a logic circuit. In some embodiments, the control circuit 1050 can be replaced by a different circuit or a component, that can perform the functions of the control circuit 1050 disclosed herein. In one configuration, the control circuit 1050 includes the first input to receive a signal indicating the number D3 of pulses from the counter circuit 1020A and the second input to receive a signal indicating the number D4 of pulses from the counter circuit 1020B. The control circuit 1050 may be also coupled to the switches SW5-SW6. In this configuration, the control circuit 1050 may configure the switches SW5-SW6 to charge or discharge the capacitor C3. While the capacitor C3 is being charged, the control circuit 1050 may receive a signal indicating the number D3 of pulses from the counter circuit 1020A. While the capacitor C3 is being discharged, the control circuit 1050 may receive a signal indicating the number D4 of pulses from the counter circuit 1020B. The control circuit 1050 may compare the number D3 of pulses and the number D4 of pulses, and determine the temperature according to the comparison. For example, if the number D4 of pulses is less than the number D3 of pulses, then the control circuit 1050 may determine that the temperature is lower than a threshold temperature Tth. For example, if the number D4 of pulses is larger than the number D3 of pulses, then the control circuit 1050 may determine that the temperature is higher than the threshold temperature Tth.

Advantageously, the device 100B can achieve an area efficacy as well as a speed efficiency. In one aspect, the device 100B may implement a single capacitor C3 for charging and discharging, rather than separate capacitors. By implementing a fewer number of capacitors, the device 100B may be implemented in a smaller area. Moreover, rather than comparing i) a time period for charging and discharging through a resistor in the layer 130 and i) another time period for charging and discharging through a resistor in the layer 110, the device 100B can compare i) the time period T3 for charging through the resistor R6 in the layer 110, and ii) the time period T4 for discharging through the resistor R5 in the layer 130, such that the device 100B can determine the temperature faster.

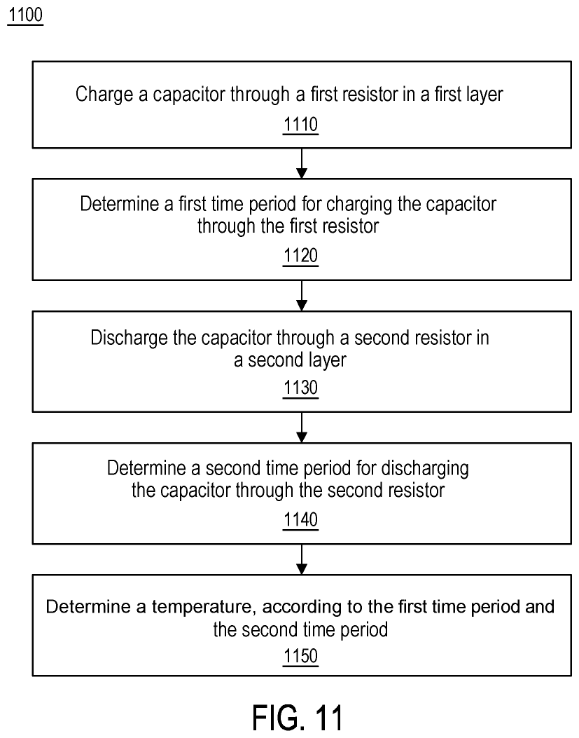

FIG. 11 is a flowchart showing a method 1100 of sensing a temperature by a device 100B including a first resistor (e.g., resistor R6) in a first layer (e.g., layer 110) and a second resistor (e.g., resistor R5) in a second layer (e.g., layer 130) below the first layer, in accordance with some embodiments. In some embodiments, the method 1100 is performed by a device (e.g., device 110B). In some embodiments, the method 1100 is performed by a different entity. In some embodiments, the method 1100 includes more, fewer, or different steps than shown in FIG. 11.

In one approach, the device charges 1110 the capacitor (e.g., capacitor C3) through the first resistor (e.g., resistor R6) in the first layer (e.g., layer 110). For example, a first switch (e.g., switch SW6) coupled to the first resistor (e.g., resistor R6) can be enabled and a second switch (e.g., switch SW5) coupled to the second resistor (e.g., resistor R5) can be disabled to charge the capacitor (e.g., capacitor C3).

In one approach, the device determines 1120 a first time period (e.g., time period T3) for charging the capacitor (e.g., capacitor C3) through the first resistor (e.g., resistor R6). For example, the device can count a number of pulses of a clock signal for a voltage at the capacitor (e.g., capacitor C3) to reach from one voltage (e.g., GND) to another voltage (e.g., VDD). The number of pulses counted (e.g., number D3 of pulses) may indicate or correspond to the first time period (e.g., time period T3).

In one approach, the device discharges 1130 the capacitor (e.g., capacitor C3) through the second resistor (e.g., resistor R5) in the second layer (e.g., layer 130). For example, the second switch (e.g., switch SW5) coupled to the second resistor (e.g., resistor R5) can be enabled and the first switch (e.g., switch SW6) coupled to the first resistor (e.g., resistor R6) can be disabled to discharge the capacitor (e.g., capacitor C3).

In one approach, the device determines 1140 a second time period (e.g., time period T4) for discharging the capacitor (e.g., capacitor C3) through the second resistor (e.g., resistor R5). For example, the device can count a number of pulses of the clock signal for a voltage at the capacitor C3 to reach from one voltage (e.g., VDD) to another voltage (e.g., GND). The number of pulses counted (e.g., number D4 of pulses) may indicate or correspond to the second time period (e.g., time period T4).

In one approach, the device determines 1150 a temperature, according to the first time period and the second time period. In one aspect, the first time period for charging and the second time period for discharging may change, according to a temperature, because the first resistor (e.g., resistor R6) in the first layer (e.g., layer 110) and the second resistor (e.g., resistor R5) in the second layer (e.g., layer 130) may have different thermal-resistance coefficients. For example, the device may compare the number of pulses counted (e.g., number D3 of pulses) for charging and the number of pulses counted (e.g., number D4 of pulses) for discharging the capacitor (e.g., capacitor C3), and determine the temperature according to the comparison. For example, if the number of pulses counted (e.g., number D3 of pulses) for charging the capacitor (e.g., capacitor C3) is larger than the number of pulses counted (e.g., the number D4 of pulses) for discharging the capacitor (e.g., capacitor C3), then the device may determine that the temperature is lower than a threshold temperature Tth. For example, if the number of pulses counted (e.g., number D3 of pulses) for charging the capacitor (e.g., capacitor C3) is less than the number of pulses counted (e.g., number D4 of pulses) for discharging the capacitor (e.g., capacitor C3), then the device may determine that the temperature is higher than the threshold temperature Tth.

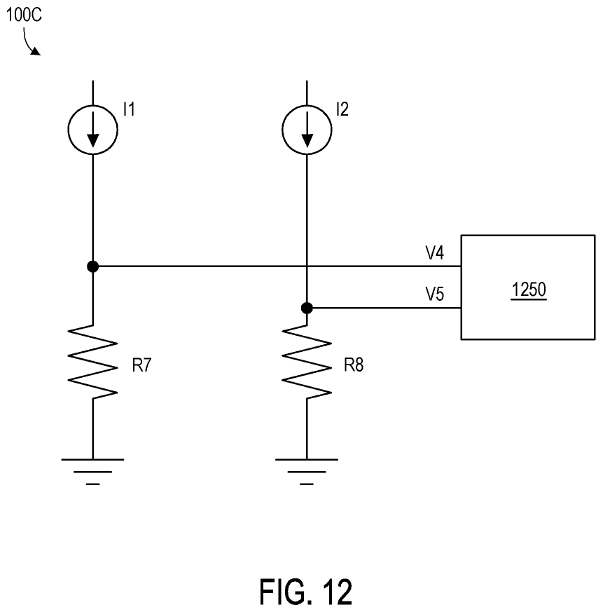

FIG. 12 is a schematic diagram of a device 100C to detect a temperature, in accordance with one embodiment. The device 100C can be the device 100 of FIG. 1. In some embodiments, the device 100C includes current sources Il, 12, resistors R7, R8, and a sensing circuit 1250. These components may operate together to detect or determine a temperature of the device 100C. In some embodiments, the resistor R7 may be a resistor in the layer 130, and the resistor R8 may be a resistor in the layer 110. In some embodiments, the current sources I1, 12 can be implemented as transistors. In some embodiments, the current sources I1, I2, and the sensing circuit 1250 are implemented in the layer 160. In some embodiments, the device 100C includes more, fewer, or different components than shown in FIG. 12.

In one configuration, the resistor R7 includes a first electrode coupled to a metal rail providing a ground voltage (e.g., GND or 0V) and a second electrode coupled to the current source I1. In one configuration, the resistor R8 includes a first electrode coupled to the metal rail providing the ground voltage (e.g., GND or 0V) and a second electrode coupled to the current source 12. In one configuration, the sensing circuit 1250 includes a first input coupled to the second electrode of the resistor R7 and a second input coupled to the second electrode of the resistor R8.

In this configuration, the sensing circuit 1250 can determine a temperature of the device 100C, based on different thermal-resistance coefficients of the resistors R7, R8. In one aspect, the sensing circuit 1250 can detect a voltage V4 of the resistor R7 in response to the current applied by the current sources I1. The sensing circuit 1250 can also detect a voltage V5 of the resistor R8, in response to the current applied by the current source I2. The current sources I1, I2 may inject the same amount of currents. According to the voltages V4, V5, the sensing circuit 1250 can detect or determine the temperature. For example, if the voltage V4 is lower than the voltage V5, then the sensing circuit 1250 may determine that the temperature is lower than a threshold temperature Tth. For example, if the voltage V4 is higher than the voltage V5, then the sensing circuit 1250 may determine that the temperature is higher than the threshold temperature Tth.

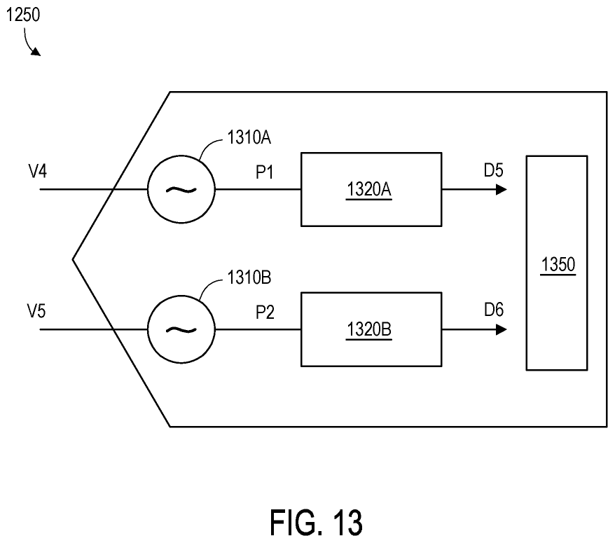

FIG. 13 is a schematic diagram of a sensing circuit 1250, in accordance with one embodiment. In some embodiments, the sensing circuit 1250 includes variable oscillators (VCOs) 1310A, 1310B, counter circuits 1320A, 1320B, and a control circuit 1350. These components may operate together to detect voltages V4, V5, and determine a temperature, according to the voltages V4, V5. In some embodiments, the sensing circuit 1250 includes more, fewer, or different components than shown in FIG. 13.

In some embodiments, the VCO 1310A is a circuit or a component that can generate pulses P1 having a frequency corresponding to the voltage V4. In some embodiments, the VCO 1310A can be replaced by a different component that can perform the functions of the VCO 1310A disclosed herein. In one configuration, the VCO 1310A includes an input to receive the voltage V4, and an output coupled to an input of the counter circuit 1320A. In this configuration, the VCO 1310A can generate pulses P1 having a frequency corresponding to the voltage V4, and provide the pulses P1 to the counter circuit 1320A.

In some embodiments, the counter circuit 1320A is a circuit or a component that can count a number of pulses P1. The counter circuit 1320A can be implemented as logic circuits, such as a set of registers or flip flops. In some embodiments, the counter circuit 1320A can be replaced by a different component that can perform the functions of the counter circuit 1320A disclosed herein. In one configuration, the counter circuit 1320A includes an input coupled to the output of the VCO 1310A, and an output coupled to a first input of the control circuit 1350. In this configuration, the counter circuit 1320A can count a number D5 of pulses for a time period, and provide a signal indicating the number D5 of pulses to the control circuit 1350.

In some embodiments, the VCO 1310B and the counter circuit 1320B can be configured and operated in a similar manner as the VCO 1310A and the counter circuit 1320A, respectively. Hence, the VCO 1310B can generate pulses P2 having a frequency corresponding to the voltage V5, and provide the pulses P2 to the counter circuit 1320B. The counter circuit 1320B can count a number D6 of pulses for a time period, and provide a signal indicating the number D6 of pulses to the control circuit 1350.

In some embodiments, the control circuit 1350 is a circuit or a component that can determine a temperature, according to the number D5 of pulses and the number D6 of pulses. In some embodiments, the control circuit 1350 is implemented as a logic circuit. In some embodiments, the control circuit 1350 can be replaced by a different circuit or a component, that can perform the functions of the control circuit 1350 disclosed herein. In one configuration, the control circuit 1350 includes the first input to receive a signal indicating the number D5 of pulses from the counter circuit 1320A and the second input to receive a signal indicating the number D6 of pulses from the counter circuit 1320B. The control circuit 1050 may compare the number D5 of pulses and the number D6 of pulses, and determine the temperature according to the comparison. For example, if the number D5 of pulses is less than the number D6 of pulses, then the control circuit 1350 may determine that the temperature is lower than a threshold temperature Tth. For example, if the number D5 of pulses is larger than the number D6 of pulses, then the control circuit 1350 may determine that the temperature is higher than the threshold temperature Tth.

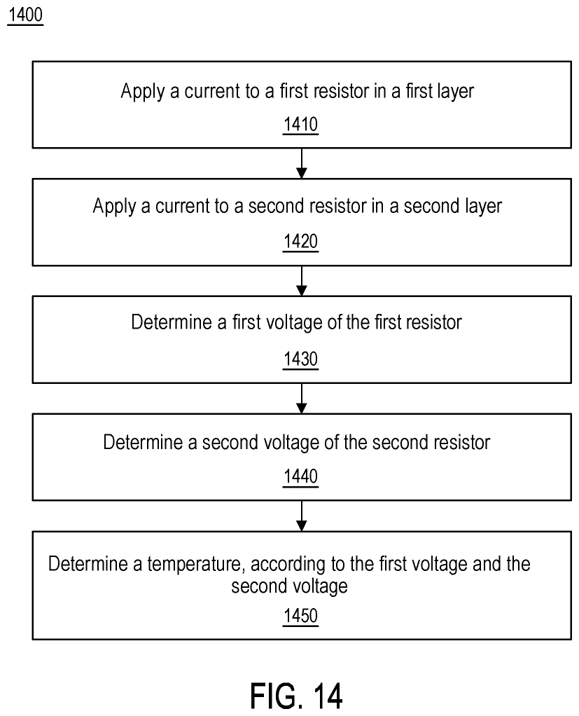

FIG. 14 is a flowchart showing a method 1400 of sensing a temperature by a device (e.g., device 100C) including a first resistor (e.g., resistor R7) in a first layer (e.g., layer 130) and a second resistor (e.g., resistor R8) in a second layer (e.g., layer 110) above the first layer, in accordance with some embodiments. In some embodiments, the method 1400 is performed by a device (e.g., device 110C). In some embodiments, the method 1400 is performed by a different entity. In some embodiments, the method 1400 includes more, fewer, or different steps than shown in FIG. 14.

In one approach, the device applies 1410 a current to the first resistor (e.g., resistor R7) in the first layer (e.g., layer 130).

In one approach, the device applies 1420 a current to the second resistor (e.g., resistor R8) in the second layer (e.g., layer 110). The device may apply the current to the second resistor (e.g., resistor R8), while applying the current to the first resistor (e.g., resistor R7).

In one approach, the device determines 1430 a first voltage (e.g., voltage V4) of the first resistor (e.g., resistor R7), in response to the current applied to the first resistor (e.g., resistor R7).

In one approach, the device determines 1440 a second voltage (e.g., voltage V5) of the second resistor (e.g., resistor R8), in response to the current applied to the second resistor (e.g., resistor R8).

In one approach, the device determines a temperature, according to the first voltage (e.g., voltage V4) of the first resistor (e.g., resistor R7) and the second voltage (e.g., voltage V5) of the second resistor (e.g., resistor R8). In one aspect, the first resistor (e.g., resistor R7) in the first layer (e.g., layer 130) and the second resistor (e.g., resistor R8) in the second layer (e.g., layer 110) may have different voltages, because the first resistor (e.g., resistor R7) and the second resistor (e.g., resistor R8) in different layers may have different thermal-resistance coefficients. The device may compare the first voltage (e.g., voltage V4) of the first resistor (e.g., resistor R7) and the second voltage (e.g., voltage V5) of the second resistor (e.g., resistor R8), and determine the temperature according to the comparison. For example, if the first voltage (e.g., voltage V4) of the first resistor (e.g., resistor R7) is lower than the second voltage (e.g., voltage V5) of the second resistor (e.g., resistor R8), then the device may determine that the temperature is lower than a threshold temperature Tth. For example, if the first voltage (e.g., voltage V4) of the first resistor (e.g., resistor R7) is higher than the second voltage (e.g., voltage V5) of the second resistor (e.g., resistor R8), then the device may determine that the temperature is higher than the threshold temperature Tth.

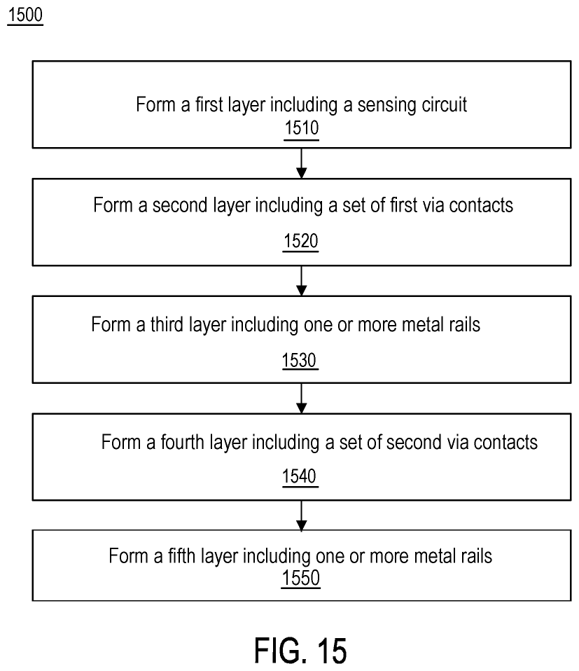

FIG. 15 is a flowchart showing a method 1500 of fabricating a device (e.g., devices 100A, 100B, 100C) including resistors in different layers for temperature sensing, in accordance with some embodiments. In some embodiments, the method 1500 is performed by a fabrication facility that can fabricate integrated circuits. In some embodiments, the method 1500 includes more, fewer, or different steps than shown in FIG. 15.

In one approach, a first layer (e.g., layer 160) including a sensing circuit (e.g., sensing circuit 350, sensing circuit 850, sensing circuit 1250) can be formed 1510. In the first layer, active components such as one or more transistors can be formed to implement the sensing circuit and other circuits (e.g., switches SW1, SW2, SW3, SW4, SW5, SW6).

In one approach, a second layer including a set of first via contacts can be formed 1520. The second layer may be formed above the first layer along the Z-direction. The second layer can be formed after forming the first layer. The second layer can be formed through deposition, etching, or a combination of them. The set of first via contacts may include conductive materials. The set of first via contacts can be implemented to electrically couple various circuits or components in the first layer (e.g., layer 160) to one or more metal rails in a higher layer (e.g., layer 130).

In one approach, a third layer (e.g., layer 130) including one or more first metal rails (e.g., metal rails 235) can be formed 1530. The third layer may be formed above the second layer along the Z-direction. The third layer can be formed after forming the second layer. In some embodiments, additional layers for additional via contacts and additional metal rails can be formed between the second layer and the third layer. The one or more first metal rails can be formed through deposition, etching, or a combination of them. The one or more first metal rails may include conductive materials. In one aspect, some metal rails in the third layer can be implemented to transfer or provide electrical signals to various circuits or components in the first layer (e.g., layer 160). In one aspect, the one or more first metal rails can operate as a first resistor (e.g., resistor R1, R2, R5, R7). In one aspect, the one or more first metal rails or the first resistor may have a first thermal-resistance coefficient.

In one approach, a fourth layer including a set of second via contacts can be formed 1540. The fourth layer may be formed above the third layer along the Z-direction. The fourth layer can be formed after forming the third layer. The set of second via contacts can be formed through deposition, etching, or a combination of them. The set of second via contacts may include conductive materials. The set of second via contacts can be implemented to electrically couple one or more metal rails in the third layer to one or more metal rails in a higher layer (e.g., layer 110).

In one approach, a fifth layer (e.g., layer 110) including one or more second metal rails (e.g., metal rails 215) can be formed 1550. The fifth layer may be formed above the fourth layer along the Z-direction. The fifth layer can be formed after forming the fourth layer. In some embodiments, additional layers for additional via contacts and additional metal rails can be formed between the fourth layer and the fifth layer. The one or more second metal rails can be formed through deposition, etching, or a combination of them. The one or more second metal rails may include conductive materials. In one aspect, some metal rails in the fifth layer can be implemented to transfer or provide electrical signals to different circuits or components in the first layer (e.g., layer 160). In one aspect, the one or more second metal rails can operate as a second resistor (e.g., resistor R3, R4, R6, R8). In one aspect, the one or more second metal rails or the second resistor may have a second thermal-resistance coefficient.

In one configuration, the sensing circuit in the first layer (e.g., layer 160) may be electrically coupled to metal rails (e.g., metal rails 235) in the third layer (e.g., layer 130) or the first resistor through via contacts in the second layer. In addition, the sensing circuit in the first layer (e.g., layer 160) may be electrically coupled to metal rails (e.g., metal rails 215) in the fifth layer (e.g., layer 110) or the second resistor through one or more via contacts in the second layer and one or more via contacts in the fourth layer. The first resistor formed by metal rails in the third layer (e.g., layer 130) and the second resistor formed by metal rails in the fifth layer (e.g., layer 110) may have different thermal-resistance coefficients. For example, a resistance of the first resistor in the third layer (e.g., layer 130) may change by a larger amount than a resistance of the second resistor in the fifth layer (e.g., layer 110), in response to an increase in a temperature. According to the difference in the thermal-resistance coefficients, the sensing circuit may determine a temperature. For example, the sensing circuit may compare voltages or timing responses of the first resistor and the second resistor in different layers, and determine a temperature according to the comparison as described herein. In one aspect, the sensing circuit can be implemented underneath the first resistor in the third layer (e.g., layer 130) and the second resistor in the fifth layer (e.g., layer 110), such that circuits or components for detecting temperature of the device can be implemented an area efficient manner.

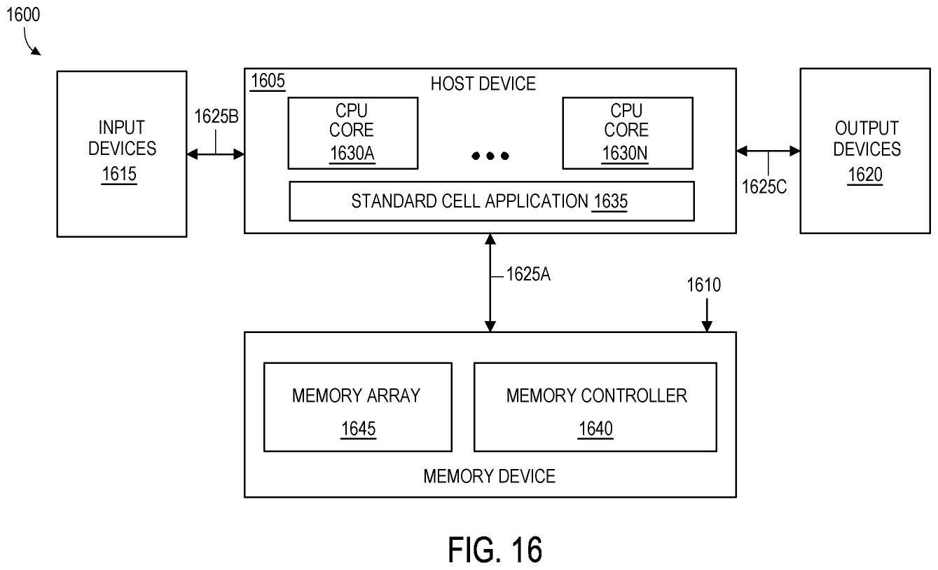

Referring now to FIG. 16, an example block diagram of a computing system 1600 is shown, in accordance with some embodiments of the disclosure. The computing system 1600 may be used by a circuit or layout designer for integrated circuit design. A “circuit” as used herein is an interconnection of electrical components such as resistors, transistors, switches, batteries, inductors, or other types of semiconductor devices configured for implementing a desired functionality. The computing system 1600 includes a host device 1605 associated with a memory device 1610. The host device 1605 may be configured to receive input from one or more input devices 1615 and provide output to one or more output devices 1620. The host device 1605 may be configured to communicate with the memory device 1610, the input devices 1615, and the output devices 1620 via appropriate interfaces 1625A, 1625B, and 1625C, respectively. The computing system 1600 may be implemented in a variety of computing devices such as computers (e.g., desktop, laptop, servers, data centers, etc.), tablets, personal digital assistants, mobile devices, other handheld or portable devices, or any other computing unit suitable for performing schematic design and/or layout design using the host device 1605.

The input devices 1615 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 1605 and that allows an external source, such as a user (e.g., a circuit or layout designer), to enter information (e.g., data) into the host device and send instructions to the host device. Similarly, the output devices 1620 may include a variety of output technologies such as external memories, printers, speakers, displays, microphones, light emitting diodes, headphones, video devices, and any other output peripherals that are configured to receive information (e.g., data) from the host device 1605. The “data” that is either input into the host device 1605 and/or output from the host device may include any of a variety of textual data, circuit data, signal data, semiconductor device data, graphical data, combinations thereof, or other types of analog and/or digital data that is suitable for processing using the computing system 1600.

The host device 1605 includes or is associated with one or more processing units/processors, such as Central Processing Unit (“CPU”) cores 1630A . . . 1630N. The CPU cores 1630A . . . 1630N may be implemented as an Application Specific Integrated Circuit (“ASIC”), Field Programmable Gate Array (“FPGA”), or any other type of processing unit. Each of the CPU cores 1630A . . . 1630N may be configured to execute instructions for running one or more applications of the host device 1605. In some embodiments, the instructions and data to run the one or more applications may be stored within the memory device 1610. The host device 1605 may also be configured to store the results of running the one or more applications within the memory device 1610. Thus, the host device 1605 may be configured to request the memory device 1610 to perform a variety of operations. For example, the host device 1605 may request the memory device 1610 to read data, write data, update or delete data, and/or perform management or other operations. One such application that the host device 1605 may be configured to run may be a standard cell application 1635. The standard cell application 1635 may be part of a computer aided design or electronic design automation software suite that may be used by a user of the host device 1605 to use, create, or modify a standard cell of a circuit. In some embodiments, the instructions to execute or run the standard cell application 1635 may be stored within the memory device 1610. The standard cell application 1635 may be executed by one or more of the CPU cores 1630A . . . 1630N using the instructions associated with the standard cell application from the memory device 1610. In one example, the standard cell application 1635 allows a user to utilize pre-generated schematic and/or layout designs of the device 100 (or device 100A, 100B, 100C) or a portion of the device 100 (or device 100A, 100B, 100C) to aid integrated circuit design. After the layout design of the integrated circuit is complete, multiples of the integrated circuit, for example, including the device 100 (or device 100A, 100B, 100C), or any portion of the device 100 (or device 100A, 100B, 100C) can be fabricated according to the layout design by a fabrication facility.

Referring still to FIG. 16, the memory device 1610 includes a memory controller 1640 that is configured to read data from or write data to a memory array 1645. The memory array 1645 may include a variety of volatile and/or non-volatile memories. For example, in some embodiments, the memory array 1645 may include NAND flash memory cores. In other embodiments, the memory array 1645 may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory array. The memories within the memory array 1645 may be individually and independently controlled by the memory controller 1640. In other words, the memory controller 1640 may be configured to communicate with each memory within the memory array 1645 individually and independently. By communicating with the memory array 1645, the memory controller 1640 may be configured to read data from or write data to the memory array in response to instructions received from the host device 1605. Although shown as being part of the memory device 1610, in some embodiments, the memory controller 1640 may be part of the host device 1605 or part of another component of the computing system 1600 and associated with the memory device 1610. The memory controller 1640 may be implemented as a logic circuit in either software, hardware, firmware, or combination thereof to perform the functions described herein. For example, in some embodiments, the memory controller 1640 may be configured to retrieve the instructions associated with the standard cell application 1635 stored in the memory array 1645 of the memory device 1610 upon receiving a request from the host device 1605.

It is to be understood that only some components of the computing system 1600 are shown and described in FIG. 16. However, the computing system 1600 may include other components such as various batteries and power sources, networking interfaces, routers, switches, external memory systems, controllers, etc. Generally speaking, the computing system 1600 may include any of a variety of hardware, software, and/or firmware components that are needed or considered desirable in performing the functions described herein. Similarly, the host device 1605, the input devices 1615, the output devices 1620, and the memory device 1610 including the memory controller 1640 and the memory array 1645 may include other hardware, software, and/or firmware components that are considered necessary or desirable in performing the functions described herein.

In one aspect of the present disclosure, a device for detecting a temperature is disclosed. In some embodiments, the device includes a first resistor including a first metal rail in a first layer. The first metal rail may having a first thermal-resistance coefficient. In some embodiments, the device includes a second resistor including a second metal rail in a second layer above the first layer along a direction. The second metal rail may have a second thermal-resistance coefficient. In some embodiments, the device includes a sensing circuit coupled to the first resistor and the second resistor. The sensing circuit may be configured to determine a temperature, according to the first metal rail having the first thermal-resistance coefficient and the second metal rail having the second thermal-resistance coefficient.

In another aspect of the present disclosure, a device for detecting a temperature is disclosed. In some embodiments, the device includes a first resistor including a first metal rail in a first layer. In some embodiments, the device includes a second resistor including a second metal rail in a second layer above the first layer along a direction. In some embodiments, the device includes a sensing circuit coupled to the first resistor and the second resistor. The sensing circuit may be configured to determine a temperature, according to a first timing response of the first resistor and a second timing response of the second resistor.

In yet another aspect of the present disclosure, a method of detecting a temperature is disclosed. In some embodiments, the method includes comparing, by a sensing circuit, a first timing response of a first metal rail and a second timing response of a second metal rail. In some embodiments, the first metal rail is disposed in a first layer, and the second metal rail is disposed in a second layer. In some embodiments, the method includes determining, by the sensing circuit, a temperature, according to the comparison.

In yet another aspect of the present disclosure, a method of fabricating a device is disclosed. In some embodiments, the method includes forming a first layer of the device. The first layer may include a sensing circuit. In some embodiments, the method includes forming a second layer of the device. The second layer may be above the first layer along a first direction. The second layer may include a first metal rail electrically coupled to the sensing circuit. In some embodiments, the method includes forming a third layer of the device. The third layer may be above the second layer along the first direction. The third layer may include a second metal rail electrically coupled to the sensing circuit. In some embodiments, the first metal rail in the second layer and the second metal rail in the third layer have different thermal-resistance coefficients. In some embodiments, the sensing circuit is configured to determine a temperature of the device, according to the different thermal-resistance coefficients of the first metal rail in the second layer and the second metal rail in the third layer.

The term “coupled” and variations thereof includes the joining of two members directly or indirectly to one another. The term “electrically coupled” and variations thereof includes the joining of two members directly or indirectly to one another through conductive materials (e.g., metal or copper traces). Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device comprising:
a first resistor including a first metal rail in a first layer, the first metal rail having a first thermal-resistance coefficient;
a second resistor including a second metal rail in a second layer above the first layer along a direction, the second metal rail having a second thermal-resistance coefficient; and
a sensing circuit coupled to the first resistor and the second resistor, the sensing circuit to determine a temperature, according to the first metal rail having the first thermal-resistance coefficient and the second metal rail having the second thermal-resistance coefficient.

2. The device of claim 1, wherein the first thermal-resistance coefficient is higher than the second thermal-resistance coefficient.

3. The device of claim 1, wherein the sensing circuit is disposed in a third layer, the first layer above the third layer along the direction.

4. The device of claim 1, wherein the sensing circuit is to:
determine a first timing response of the first metal rail, according to the first thermal-resistance coefficient,
determine a second timing response of the second metal rail, according to the second thermal-resistance coefficient, and
determine the temperature, according to the first timing response and the second timing response.

5. The device of claim 4, wherein the sensing circuit is to:
determine that the temperature is lower than a threshold temperature, in response to the first timing response of the first metal rail being shorter than the second timing response of the second metal rail.

6. The device of claim 4, further comprising:
a first switch coupled to the first resistor;
a first capacitor coupled to the first switch;
a second switch coupled to the second resistor; and
a second capacitor coupled to the second switch,
wherein the first switch is toggled to obtain the first timing response, and
wherein the second switch is toggled to obtain the second timing response.

7. The device of claim 6,
wherein the first switch is to electrically couple the first resistor to the first capacitor during a first time period to obtain the first timing response, and
wherein the second switch is to electrically couple the second resistor to the second capacitor during the first time period to obtain the second timing response.

8. The device of claim 7,
wherein the first switch is to electrically decouple the first resistor from the first capacitor during a second time period, and
wherein the second switch is to electrically decouple the second resistor from the second capacitor during the second time period.

9. The device of claim 6,
wherein the first capacitor includes a set of metal plates disposed between the first layer and the second layer.

10. The device of claim 9,
wherein the sensing circuit is disposed in a third layer, and
wherein the first capacitor includes another set of metal plates disposed between the first layer and the third layer.

11. The device of claim 4, further comprising:
a first switch coupled to the first resistor;
a capacitor coupled to the first switch; and
a second switch coupled to the second resistor, the second switch coupled to the capacitor,
wherein the first switch is toggled to obtain the first timing response, and wherein the second switch is toggled to obtain the second timing response.

12. The device of claim 11,
wherein the first switch is to electrically couple the first resistor to the capacitor during a first time period to obtain the first timing response, and
wherein the second switch is to electrically decouple the second resistor from the capacitor during the first time period.

13. The device of claim 12,
wherein the second switch is to electrically couple the second resistor to the capacitor during a second time period to obtain the second timing response, and
wherein the first switch is to electrically decouple the first resistor from the capacitor during the second time period.

14. The device of claim 1, further comprising:
a first current source to inject a current to the first resistor, the first resistor having a first voltage according to the first thermal-resistance coefficient, in response to the current; and
a second current source to inject the current to the second resistor, the second resistor having a second voltage according to the second thermal-resistance coefficient, in response to the current,
wherein the sensing circuit is to determine the temperature, based on the first voltage and the second voltage.

15. A device comprising:
a first resistor including a first metal rail in a first layer;
a second resistor including a second metal rail in a second layer above the first layer along a direction; and
a sensing circuit coupled to the first resistor and the second resistor, the sensing circuit to determine a temperature, according to a first timing response of the first resistor and a second timing response of the second resistor.

16. The device of claim 15, wherein the sensing circuit is disposed in a third layer, the first layer above the third layer along the direction.

17. The device of claim 15, further comprising:
a first switch coupled to the first resistor;
a first capacitor coupled to the first switch;
a second switch coupled to the second resistor; and
a second capacitor coupled to the second switch,
wherein the first switch is toggled to obtain the first timing response, and
wherein the second switch is toggled to obtain the second timing response.

18. The device of claim 15, further comprising:
a first switch coupled to the first resistor;
a capacitor coupled to the first switch; and
a second switch coupled to the second resistor, the second switch coupled to the capacitor,
wherein the first switch is toggled to obtain the first timing response, and wherein the second switch is toggled to obtain the second timing response.

19. A method comprising:
forming a first layer of a device, the first layer including a sensing circuit;
forming a second layer of the device, the second layer above the first layer along a first direction, the second layer including a first metal rail electrically coupled to the sensing circuit; and
forming a third layer of the device, the third layer above the second layer along the first direction, the third layer including a second metal rail electrically coupled to the sensing circuit,
wherein the first metal rail in the second layer and the second metal rail in the third layer have different thermal-resistance coefficients, and
wherein the sensing circuit is to determine a temperature of the device, according to the different thermal-resistance coefficients of the first metal rail in the second layer and the second metal rail in the third layer.

20. The method of claim 19, further comprising:
forming a fourth layer of the device after forming the first layer and prior to forming the second layer, the fourth layer above the first layer along the first direction, the fourth layer including a set of first via contacts, wherein the sensing circuit is electrically coupled to the first metal rail in the second layer through a first subset of the set of first via contacts in the fourth layer; and
forming a fifth layer of the device after forming the second layer and prior to forming the third layer, the fifth layer above the second layer along the first direction, the fifth layer including a set of second via contacts, wherein the sensing circuit is electrically coupled to the second metal rail in the third layer through a second subset of the set of first via contacts in the fourth layer and a third subset of the set of second via contacts in the fifth layer.
